(19) United States
(12) Patent Application Publication
(10) Pub. No.: US 2020/0171974 A1
(43) Pub. Date: Jun. 4, 2020

(54) CHARGE CONTROL APPARATUS FOR VEHICLE

(71) Applicant: DENSO TEN Limited, Kobe-shi (JP)

(72) Inventor: Tatsuya IKEDA, Kobe-shi (JP)

(73) Assignee: DENSO TEN Limited, Kobe-shi (JP)

(21) Appl. No.: 16/686,605

(22) Filed: Nov. 18, 2019

(30) Foreign Application Priority Data
Nov. 30, 2018 (JP) 2018-224461

(51) Int. Cl. B60L 58/24; B60L 58/20; B60L 1/00; H01M 10/613; H01M 10/44; H01M 10/48

(52) U.S. Cl. CPC B60L 58/24; B60L 58/20; B60L 1/003; H01M 10/613; H01M 2220/20; H01M 10/486; B60L 2210/10; B60L 2250/22; H01M 10/443

(57) ABSTRACT

A vehicle-mounted charge control apparatus includes: a voltage converter that converts a voltage output from a voltage supplier on a vehicle and supplies the converted voltage to a storage battery on the vehicle; a temperature adjuster that adjusts a temperature of the voltage converter while the voltage converter is working; a person detector that detects whether or not a person is in a cabin of the vehicle; and a controller that controls the voltage converter to supply the converted voltage to the storage battery in a case where the person detector detects that no person is in the cabin of the vehicle.

### BACKGROUND OF THE INVENTION

### Field of the Invention

The invention relates to a battery charge control apparatus and a battery charge control method for vehicle.

### Description of the Background Art

An electric vehicle uses a motor as a driving source, and a hybrid vehicle uses an engine and a motor as a driving source. Those vehicles include a high voltage battery that supplies electric power to the motor and a low voltage battery that supplies electric power to a car navigation system and the like. Conventionally, the low voltage battery is charged with the electric power of the high voltage battery by use of a converter included in the hybrid vehicle. Thus, the low voltage battery is charged while an ignition switch is OFF to secure electric power for the low voltage battery when the ignition switch is turned ON.

However, there is a problem that comfort of a person in a cabin of the vehicle will be damaged if the person hears noise generated along with work of the converter.

### SUMMARY OF THE INVENTION

According to one aspect of the invention, a vehicle-mounted charge control apparatus includes: a voltage converter that converts a voltage output from a voltage supplier on a vehicle and supplies the converted voltage to a storage battery on the vehicle; a temperature adjuster that adjusts a temperature of the voltage converter while the voltage converter is working; a person detector that detects whether or not a person is in a cabin of the vehicle; and a controller that controls the voltage converter to supply the converted voltage to the storage battery in a case where the person detector detects that no person is in the cabin of the vehicle.

An object of the invention is to provide a vehicle-mounted charge control apparatus and a vehicle-mounted charge control method for preventing a person in a cabin of a vehicle from hearing noise generated along with work of a converter.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an example of a schematic view of a vehicle having a charge control apparatus of an embodiment of the invention;

FIG. 2 is a block diagram of the charge control apparatus mounted on the vehicle shown in FIG. 1;

FIG. 3 illustrates an example of a work outline of the charge control apparatus mounted on the vehicle shown in FIG. 1 in a case where no person is in a cabin of a vehicle;

FIG. 4 illustrates an example of a work outline of the charge control apparatus mounted on the vehicle shown in FIG. 1 in the case where sound in the cabin is greater than a predetermined value;

FIG. 5 illustrates an example of a work outline of the charge control apparatus mounted on the vehicle shown in FIG. 1 in the case a voltage of a lead battery decreases;

FIG. 6 is an example of a flowchart of the charge control apparatus mounted on the vehicle shown in FIG. 1; and

FIG. 7 illustrates a configuration of a BUS connecting a CPU.

### DESCRIPTION OF THE EMBODIMENTS

Embodiments of the invention will be described below with reference to the drawings. The invention is not limited to the embodiments described below. The embodiments are only examples. The invention can be changed, modified and improved based on wisdom of a person skilled in the art and can be realized in various modes. Configuration elements having a same numeral reference in this description and the drawings are same or equivalent to each other.

### First Embodiment

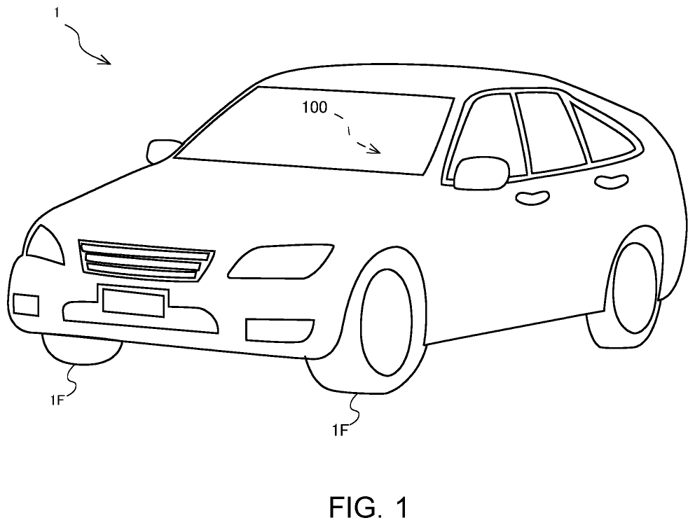

FIG. 1 is a schematic view of a vehicle 1 having a charge control apparatus of a first embodiment of the invention. As shown in FIG. 1, the vehicle 1 includes a cabin 100. When a passenger gets into the vehicle 1, the passenger comes into the cabin 100. In the vehicle 1, a drive wheel 1F is a drive wheel of the vehicle 1.

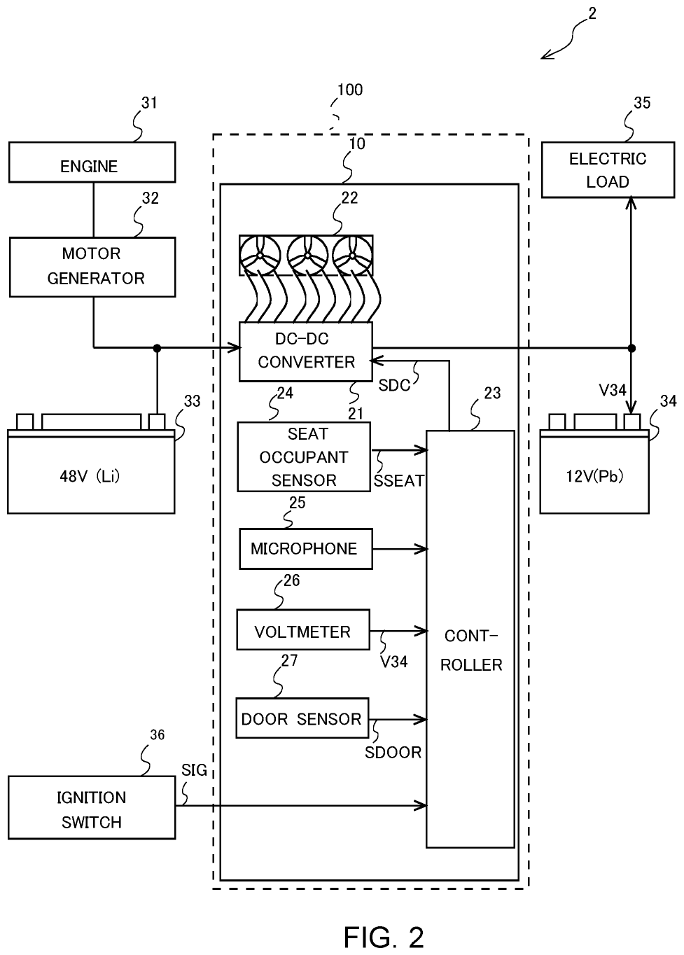

FIG. 2 is an outline of an electric power system 2 included in the vehicle 1. The electric power system 2 shown in FIG. 2 includes a charge control apparatus 10, an engine 31, a motor generator 32, a lithium ion battery 33, a lead battery 34, an electric load 35, and an ignition switch 36. The lithium ion battery 33 functions as a voltage supplier. The lead battery 34 functions as a storage battery.

The engine 31 is an internal combustion engine. The engine 31 drives the drive wheel 1F of the vehicle 1. The drive wheel 1F may be driven by a drive motor (not illustrated).

Using power supplied from the lithium ion battery 33, the motor generator 32 rotates the engine 31 when the engine 31 is started. The motor generator 32 generates power by use of output of the engine 31 when the engine 31 is working. The motor generator 32 supplies voltage to the charge control apparatus 10 and the lithium ion battery 33.

The lithium ion battery 33 is a power source of the motor generator 32 and the drive motor (not illustrated) that rotates the drive wheel 1F. The vehicle 1 in this embodiment can be so-called mild-hybrid by using the engine 31 and the drive motor (not illustrated) that drives the drive wheel 1F.

The lead battery 34 is an accessory power source. The lead battery 34 outputs an output voltage V34. Energy that the lead battery 34 can store is smaller than energy that the lithium ion battery 33 can store.

The electric load 35 is an accessory mounted on the vehicle 1. The electric load 35 works with supplied power at a predetermined voltage. Some examples among the electric loads 35 are the car navigation system, an air conditioner, various sensors that detect surroundings of the vehicle, and a headlight included in the vehicle.

The ignition switch 36 is operated by a driver of the vehicle 1, and then outputs an ignition signal SIG to provide an instruction of turning the ignition and/or the accessory ON or OFF. A power source of the ignition is the motor generator 32 and the lithium ion battery 33.

The charge control apparatus 10 converts the voltage supplied from the lithium ion battery 33, and supplies the converted voltage to the lead battery 34. The charge control apparatus 10 is mounted in the cabin 100. The charge control apparatus 10 includes: a DC-DC converter 21 that functions as a voltage converter; a fan 22 that functions as a temperature adjuster; a controller 23; a seat occupant sensor 24 and a door sensor 27 at least one of which functions as a person detection sensor; a microphone 25 that functions as a sound detector; and a voltmeter 26 that functions as a voltage detector.

The DC-DC converter 21 outputs a voltage different from an input voltage. The DC-DC converter 21 is connected to the lithium ion battery 33, the motor generator 32 and the lead battery 34.

The DC-DC converter 21 converts the voltage output from the lithium ion battery 33, and supplies the converted voltage to the lead battery 34 to charge the lead battery 34. The DC-DC converter 21 is controlled by a control signal SDC that is output by the controller 23. When the control signal SDC is ON, the DC-DC converter 21 works. When the control signal SDC is OFF, the DC-DC converter 21 stops. In this embodiment, charge of the lead battery 34 by use of the DC-DC converter 21 is performed before the lithium ion battery 33 is so low that the lithium ion battery 33 is degraded.

The fan 22 adjusts a temperature of the DC-DC converter 21 while the DC-DC converter 21 is working. For example, while the DC-DC converter 21 is working, the fan 22 fans the DC-DC converter 21 to cool the DC-DC converter 21.

The seat occupant sensor 24 detects a weight applied on a seat to detect whether or not the seat is occupied by a person. The seat occupant sensor 24 outputs, to the controller 23, a signal SSEAT indicative of a result of detection. When the signal SSEAT is ON, the signal SSEAT indicates that the seat is occupied. When the signal SSEAT is OFF, the signal SSEAT indicates that the seat is not occupied.

The microphone 25 converts sound in the cabin 100 into an electric signal. The microphone 25 is, for example, included in a car navigation system. In the description below, a voltage of the electric signal produced by the microphone 25 indicates a volume of the sound in the cabin. The voltage of the electric signal produced and output by the microphone 25 will be referred below to as “output voltage VMIC.”

The voltmeter 26 detects the output voltage V34 of the lead battery 34. The voltmeter 26 outputs, to the controller 23, the detected output voltage V34 of the lead battery 34.

The door sensor 27 detects whether or not a door is open. The door sensor 27 outputs, to the controller 23, a signal SDOOR indicative of a result of detection. When the signal SDOOR is ON, the signal SDOOR indicates that the door is closed. When the signal SDOOR is OFF, the signal SDOOR indicates that the door is open.

The controller 23 controls the DC-DC converter 21. Moreover, the controller 23 receives the ignition signal SIG output by the ignition switch 36. The controller 23 determines whether or not a person is in the cabin 100 based on the signal SSEAT indicative of the detection result from the seat occupant sensor 24, the signal SDOOR indicative of the detection result from the door sensor 27, and the ignition signal SIG

The controller 23 determines, based on a movement of a person to come into or come out of the vehicle 1, whether or not the person is in the cabin 100. For example, when coming out of the vehicle 1, the person comes out from the cabin 100. When coming out from the cabin 100, the person first opens a door and then gets out of the seat. Then the person comes out to an outside of the cabin 100 and closes the door. When coming into the vehicle 1, the person comes into the cabin 100. When coming into the cabin 100, the person first opens the door, and then comes into the cabin 100, and sits down on the seat. Then the person closes the door. The controller 23 detects such a movement and determines whether the person comes into the cabin 100 or comes out from the cabin 100. Therefore, the controller 23 determines whether or not a person is in the cabin 100 of the vehicle 1 based on the signal SSEAT indicative of the detection result from the seat occupant sensor 24 and the signal SDOOR indicative of the detection result from the door sensor 27. For example, when a person is in the seat and the door is closed, the controller 23 determines that the person is in the cabin 100 of the vehicle 1.

Once the controller 23 determines that no person is the cabin 100 of the vehicle 1, the controller 23 activates the DC-DC converter 21 and the fan 22. Once the controller 23 determines that no person is in the cabin 100, the controller 23 disables a control based on a maximum fan noise Sfanmax, described later, and rotates the fan 22 maximally (i.e., at a maximum revolution speed).

The controller 23 determines a volume of a noise in the cabin 100 of the vehicle 1 based on the output voltage VMIC of the microphone 25. When the volume of the noise in the cabin 100 is greater than a predetermined threshold, the controller 23 causes the DC-DC converter 21 to work if a person is in the cabin 100. For example, when the output voltage VMIC of the microphone 25 is greater than a threshold VMICth, the controller 23 activates the DC-DC converter 21.

The controller 23 determines the maximum fan noise Sfanmax. The maximum fan noise Sfanmax is a largest volume of a noise that the fan 22 is allowed to generate. The controller 23 controls the DC-DC converter 21 to make a fan noise Sfan generated by the fan 22 equal to or smaller than the maximum fan noise Sfanmax. The controller 23 determines the maximum fan noise Sfanmax, using the volume of the noise in the cabin 100 detected by the microphone 25 as a benchmark. The maximum fan noise Sfanmax is smaller than the volume of the noise of the cabin 100.

<Work of the Charge Control Apparatus 10>

Work of the charge control apparatus 10 in a case where the ignition signal SIG is OFF will be described below. When the ignition signal SIG is OFF, the ignition signal SIG indicates that both an ignition and an accessory power are OFF. First, a reason for which the DC-DC converter 21 is cooled will be described.

When the lead battery 34 continues to discharge electricity, the output voltage V34 of the lead battery 34 is lowered. When the output voltage V34 of the lead battery 34 is below a rated voltage, the electric load 35 may malfunction. Therefore, the controller 23 charges the lead battery 34 not to cause the output voltage V34 of the lead battery 34 to be below the rated voltage.

The controller 23 uses the DC-DC converter 21 to charge the lead battery 34. The DC-DC converter 21 converts an output voltage of the lithium ion battery 33. The DC-DC converter 21 outputs the converted voltage to the lead battery 34. The output voltage of the lithium ion battery 33 is, for example, 48 V. The voltage input from the DC-DC converter 21 to the lead battery 34 is, for example, 12 V. In this case, the DC-DC converter 21 converts the 48 V direct current voltage into 12 V direct current voltage.

When converting voltage, the DC-DC converter 21 generates heat. If a temperature of the DC-DC converter 21 exceeds a usable temperature, the DC-DC converter 21 may be damaged. Therefore, the controller 23 causes the fan 22 to fan the DC-DC converter 21. Air sent to the DC-DC converter 21 cools the DC-DC converter 21.

<When No Person is in the Cabin 100>

The fan 22 generates the noise while working. The noise generated by the fan 22 may damage comfort of the person in the cabin 100 of the vehicle 1. Therefore, once determining that no person is in the cabin 100 of the vehicle 1, the controller 23 starts charging the lead battery 34.

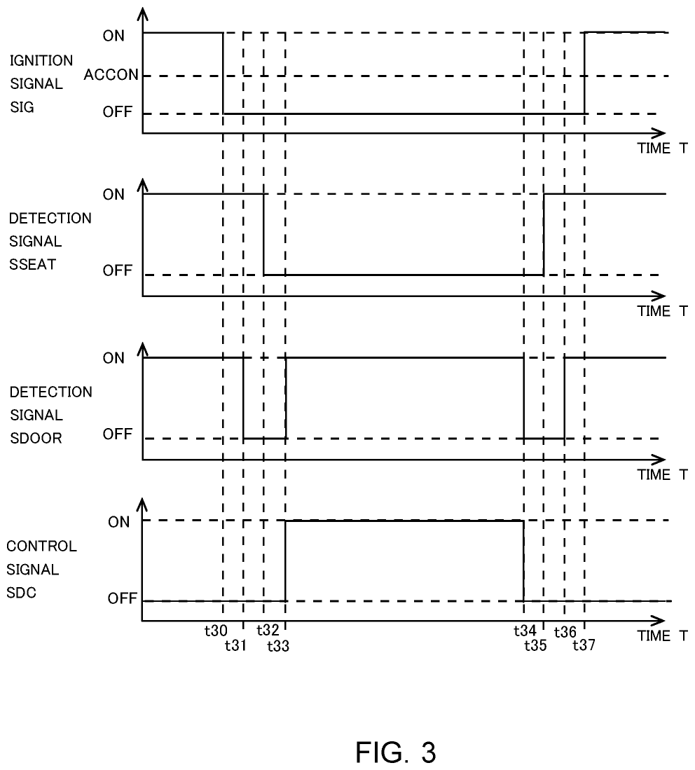

FIG. 3 is a timing chart illustrating work of the charge control apparatus 10 in a case where no person is determined to be in the cabin 100 of the vehicle 1. With reference to FIG. 3, the work of the charge control apparatus 10 in the case where no person is determined to be in the cabin 100 will be described.

Before a time point t30, the ignition signal SIG the signal SSEAT indicative of the detection result from the seat occupant sensor 24, and the signal SDOOR indicative of the detection result from the door sensor 27 are all ON. In this case, the controller 23 determines that a person is in the cabin 100 of the vehicle 1. The controller 23 keeps the DC-DC converter 21 and the fan 22 stopped.

In a time period from the time point t30 to a time point t31, the ignition signal SIG is OFF, and the signal SSEAT indicative of the detection result from the seat occupant sensor 24 is ON, and the signal SDOOR indicative of the detection result from the door sensor 27 is ON. In this case, the controller 23 determines that the person is in the cabin 100. The controller 23 keeps the DC-DC converter 21 and the fan 22 stopped in the time period from the time point t30 to the time point t31.

In a time period from the time point t31 to a time point t32, the ignition signal SIG is OFF, the signal SSEAT indicative of the detection result from the seat occupant sensor 24 is ON, and the signal SDOOR indicative of the detection result from the door sensor 27 is OFF. In this case, the controller 23 determines that the person is in the cabin 100. The controller 23 keeps the DC-DC converter 21 and the fan 22 stopped in the time period from the time point t31 to the time point t32.

In a time period from the time point t32 to a time point t33, the ignition signal SIG is OFF, the signal SSEAT indicative of the detection result from the seat occupant sensor 24 is OFF, and the signal SDOOR indicative of the detection result from the door sensor 27 is OFF. In this case, the controller 23 determines that the person is in the cabin 100. The controller 23 keeps the DC-DC converter 21 and the fan 22 stopped in the time period from the time point t32 to the time point t33.

In a time period from the time point t33 to a time point t34, the ignition signal SIG and the signal SSEAT indicative of the detection result from the seat occupant sensor 24 are OFF, and the signal SDOOR indicative of the detection result from the door sensor 27 is ON. In this case, the controller 23 determines that no person is in the cabin 100. The controller 23 causes the DC-DC converter 21 and the fan 22 to work in the time period from the time point t33 to the time point t34. More specifically, the controller 23 disables the control based on the maximum fan noise Sfanmax, and rotates the fan 22 maximally.

In a time period from the time point t34 to a time point t35, the ignition signal SIG and the signal SSEAT indicative of the detection result from the seat occupant sensor 24, and the signal SDOOR indicative of the detection result from the door sensor 27 are all OFF. In this case, the controller 23 determines that the person is in the cabin 100. The controller 23 keeps the DC-DC converter 21 and the fan 22 stopped in the time period from the time point t34 to the time point t35.

In a time period from the time point t35 to a time point t36, the ignition signal SIG is OFF, the signal SSEAT indicative of the detection result from the seat occupant sensor 24 is ON, and the signal SDOOR indicative of the detection result from the door sensor 27 is OFF. In this case, the controller 23 determines that the person is in the cabin 100. The controller 23 keeps the DC-DC converter 21 and the fan 22 stopped in the time period from the time point t35 to the time point t36.

In a time period from the time point t36 to a time point t37, the ignition signal SIG is OFF, the signal SSEAT indicative of the detection result from the seat occupant sensor 24 is ON, and the signal SDOOR indicative of the detection result from the door sensor 27 is ON. In this case, the controller 23 determines that the person is in the cabin 100. The controller 23 keeps the DC-DC converter 21 and the fan 22 stopped in the time period from the time point t36 to the time point t37.

After the time point t37, the ignition signal SIG; the signal SSEAT indicative of the detection result from the seat occupant sensor 24, and the signal SDOOR indicative of the detection result from the door sensor 27 are all ON. In this case, the controller 23 determines that the person is in the cabin 100. The controller 23 keeps the DC-DC converter 21 and the fan 22 stopped from the time point t37.

When detecting that no person is in the cabin 100 of the vehicle 1, the charge control apparatus 10 for vehicle of this embodiment causes the lead battery 34 to be charged. Therefore, the charge control apparatus 10 for vehicle can prevent the person in the cabin 100 from hearing the noise generated along with the work of the DC-DC converter 21 and the fan 22.

<Case in Which a Noise in the Cabin 100 is Beyond the Predetermined Threshold>

The noise generated by the fan 22 may damage the comfort of the person in the cabin 100. However, there is a case in which loud sound is heard in the cabin 100. One example is a case in which music is played loudly in the cabin 100. In such a case, if the noise generated by the fan 22 is smaller enough than the sound of the music, a possibility that the noise generated by the fan 22 will damage the comfort of the person in the cabin 100, is low. In a case where the output voltage VMIC of the microphone 25 that detects the sound in the cabin 100 is greater than the threshold VMICth, the controller 23 causes the lead battery 34 to be charged.

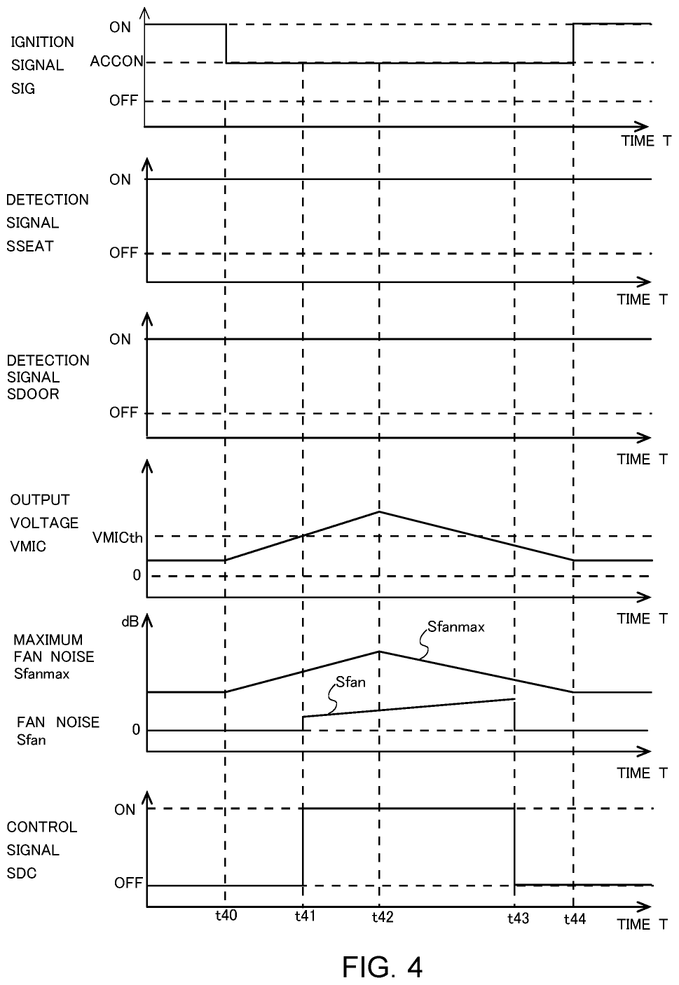

With reference to FIG. 4, next will be described work of the charge control apparatus 10 in the case where the output voltage VMIC of the microphone 25 that detects the sound in the cabin 100 is greater than the threshold VMICth.

Before a time point t40, the ignition signal SIG, the signal SSEAT indicative of the detection result from the seat occupant sensor 24, and the signal SDOOR indicative of the detection result from the door sensor 27 are all ON. Moreover, before the time point t40, the output voltage VMIC of the microphone 25 is smaller than the threshold VMICth. In this case, the controller 23 determines that the person is in the cabin 100 and that a volume of the sound in the cabin 100 is smaller than a volume of a sound corresponding to the threshold VMICth. The controller 23 causes the DC-DC converter 21 and the fan 22 to stop before the time point t40.

When the ignition signal SIG is ACCON, the ignition signal SIG indicates that the ignition is OFF and the accessory power is ON. In a time period from the time point t40 to a time point t41, the ignition signal SIG is ACCON, the signal SSEAT indicative of the detection result from the seat occupant sensor 24 and the signal SDOOR indicative of the detection result from the door sensor 27 are ON. Moreover, in the time period from the time point t40 to the time point t41, the output voltage VMIC of the microphone 25 is smaller than the threshold VMICth. In this case, the controller 23 determines that the person is in the cabin 100 and that the sound in the cabin 100 is smaller than the sound corresponding to the threshold VMICth. The controller 23 causes the DC-DC converter 21 and the fan 22 to stop in the time period from the time point t40 to the time point t41.

In a time period from the time point t41 to a time point t42, the ignition signal SIG is ACCON, the signal SSEAT indicative of the detection result from the seat occupant sensor 24 and the signal SDOOR indicative of the detection result from the door sensor 27 are ON. Moreover, in the time period from the time point t41 to the time point t42, the output voltage VMIC of the microphone 25 is greater than the threshold VMICth. In this case, the controller 23 determines that the person is in the cabin 100 and that the sound in the cabin 100 is greater than the sound corresponding to the threshold VMICth. The controller 23 causes the DC-DC converter 21 to work in the time period from the time point t41 to the time point t42. The controller 23 controls a revolution speed (i.e., revolutions) of the fan 22 to make the fan noise Sfan generated by the fan 22 smaller than the maximum fan noise Sfanmax. The controller 23 controls the revolution speed of the fan 22 based on, for example, data associating the revolution speeds of the fan 22 with volumes of the noises generated by the fan 22.

A reason for which the maximum fan noise Sfanmax increases in a time period from the time point t40 to a time point t43, and the fan noise Sfan increases in a time period from the time point t42 to the time point t43 will be described later.

In the time period from the time point t42 to the time point t43, the ignition signal SIG is ACCON, and the signal SSEAT indicative of the detection result from the seat occupant sensor 24 and the signal SDOOR indicative of the detection result from the door sensor 27 are ON. Moreover, in the time period from the time point t42 to the time point t43, the output voltage VMIC of the microphone 25 is greater than the threshold VMICth. In this case, the controller 23 determines that the person is in the cabin 100 and that the sound in the cabin 100 is greater than the sound corresponding to the threshold VMICth. The controller 23 keeps the DC-DC converter 21 working in the time period from the time point t42 to the time point t43. The controller 23 controls the revolution speed of the fan 22 to make the fan noise Sfan generated by the fan 22 smaller than the maximum fan noise Sfanmax in the time period.

When the ignition signal SIG is ON, the ignition signal SIG indicates that both the ignition and the accessory power are ON. When the ignition is ON, at least one of the motor generator 32, the lithium ion battery 33 and the drive motor, not illustrated, supplies power. In a time period from the time point t43 to a time point t44, the ignition signal SIG is ACCON, and the signal SSEAT indicative of the detection result from the seat occupant sensor 24 and the signal SDOOR indicative of the detection result from the door sensor 27 are ON. Moreover, in the time period from the time point t43 to the time point t44, the output voltage VMIC of the microphone 25 is smaller than the threshold VMICth. In this case, the controller 23 determines that the person is in the cabin 100 and that the sound in the cabin 100 is smaller than the threshold VMICth. The controller 23 causes the DC-DC converter 21 to stop in the time period from the time point t43 to the time point t44. The controller 23 keeps the fan 22 stopped in accordance with the stop of the DC-DC converter 21.

After the time point t44, the ignition signal SIG; the signal SSEAT indicative of the detection result from the seat occupant sensor 24 and the signal SDOOR indicative of the detection result from the door sensor 27 are all ON. Moreover, after the time point t44, the output voltage VMIC of the microphone 25 is smaller than the threshold VMICth. In this case, the controller 23 determines that the person is in the cabin 100 and that the sound in the cabin 100 is smaller than the sound corresponding to the threshold VMICth. The controller 23 keeps the DC-DC converter 21 and the fan 22 stopped after the time point t44.

This charging to the lead battery 34 is performed when a person “is” determined (detected) to be in the cabin 100. When “no” person is determined to be in the cabin 100, as described with reference to FIG. 3, the charging to the lead battery 34 can be performed regardless of the volume of the sound in the cabin 100. Therefore, in the case where the sound in the cabin 100 is greater than the threshold, the charge control apparatus 10 for vehicle of this embodiment can charge the lead battery 34 regardless of whether a person is determined to be in the cabin 100 of the vehicle 1.

The charge control apparatus 10 for vehicle of this embodiment charges the lead battery 34 in the case where the sound in the cabin 100 is greater than the threshold. Therefore, the charge control apparatus 10 for vehicle can prevent the person in the cabin 100 from hearing the operation sound of the DC-DC converter 21 and the fan 22. The charge control apparatus 10 for vehicle of the embodiment controls the revolution speed of the fan 22 that cools the DC-DC converter 21 that generates heat while working. Thus, the operation noise of the fan 22 can be changed according to the volume of the sound in the cabin 100. Therefore, the charge control apparatus 10 can prevent the person in the cabin 100 from hearing the noise generated along with the operation of the DC-DC converter 21 and the fan 22. Moreover, the charge control apparatus 10 of the embodiment can improve cooling efficiency of the DC-DC converter 21.

<When the Voltage of the Lead Battery 34 Decreases>

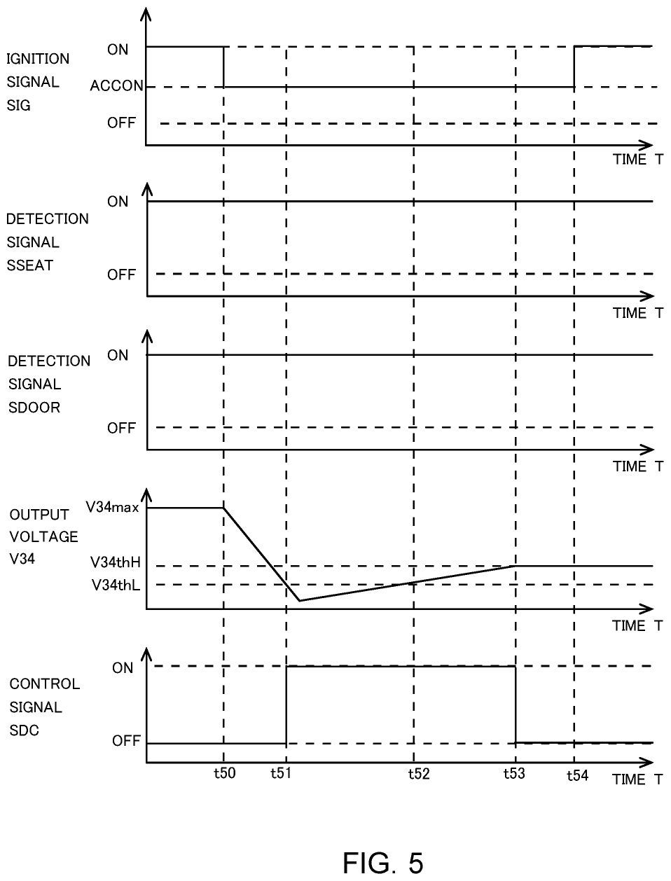

FIG. 5 is a timing chart illustrating work of the charge control apparatus 10 in a case where the voltage of the lead battery 34 decreases. The electric load 35 works with voltage supplied from the lead battery 34. Thus, there is a case in which the output voltage V34 of the lead battery 34 becomes smaller than a predetermined value. Here, the predetermined value is a charging start voltage V34thL shown in FIG. 5, and is, for example, a nominal voltage (12 V) of the lead battery 34. For example, in the description below, the electric load 35 is a car navigation system, and a power supply voltage of the car navigation system is 10.5 V to 15.8 V. In this case, the output voltage V34 of the lead battery 34 is kept greater than the nominal voltage so that it is possible to prevent malfunction of the electric load 35 including the car navigation system.

In the case where the output voltage V34 of the lead battery 34 is below the charging start voltage V34thL, the controller 23 causes the lead battery 34 to be charged until the output voltage V34 of the lead battery 34 becomes a charging end voltage V34thH. In the case where the output voltage V34 of the lead battery 34 is below the charging start voltage V34thL, the controller 23 starts to charge the lead battery 34 regardless of whether a person is determined to be in the cabin 100 of the vehicle 1.

With reference to FIG. 5, next will be described work of the charge control apparatus 10 in the case where the output voltage V34 of the lead battery 34 becomes smaller than the charging start voltage V34thL.

Before a time point t50, the ignition signal SIG the signal SSEAT indicative of the detection result from the seat occupant sensor 24, and the signal SDOOR indicative of the detection result from the door sensor 27 are all ON. Moreover, before the time point t50, the output voltage V34 of the lead battery 34 is a value V34max greater than the charging start voltage V34thL. In a case where the output voltage V34 of the lead battery 34 is the value V34max, the lead battery 34 is fully charged. In this case, the controller 23 determines that the person is in the cabin 100 of the vehicle 1 and the output voltage V34 of the lead battery 34 is greater than the charging start voltage V34thL. The controller 23 causes the DC-DC converter 21 and the fan 22 to stop before the time point t50.

In a time period from the time point t50 to a time point t51, the ignition signal SIG is ACCON, and the signal SSEAT indicative of the detection result from the seat occupant sensor 24 and the signal SDOOR indicative of the detection result from the door sensor 27 are ON. Moreover, in the time period from the time point t50 to the time point t51, the output voltage V34 of the lead battery 34 is greater than the charging start voltage V34thL. In this case, the controller 23 determines that the person is in the cabin 100 of the vehicle 1 and that the output voltage V34 of the lead battery 34 is greater than the charging start voltage V34thL. The controller 23 keeps the DC-DC converter 21 and the fan 22 stopped in the time period from the time point t50 to the time period t51.

In a time period from the time point t51 to a time point t52, the ignition signal SIG is OFF, and the signal SSEAT indicative of the detection result from the seat occupant sensor 24 and the signal SDOOR indicative of the detection result from the door sensor 27 are ON. In the time period from the time point t51 to the time point t52, the output voltage V34 of the lead battery 34 is smaller than the charging start voltage V34thL. In this case, the controller 23 determines that the person is in the cabin 100 of the vehicle 1 and that the output voltage V34 of the lead battery 34 is smaller than the charging start voltage V34thL. The controller 23 causes the DC-DC converter 21 and the fan 22 to work in the time period from the time point t51 to the time period t52.

In a time period from the time point t52 to a time point t53, the ignition signal SIG is OFF, and the signal SSEAT indicative of the detection result from the seat occupant sensor 24 and the signal SDOOR indicative of the detection result from the door sensor 27 are ON. In the time period from the time point t52 to the time point t53, the output voltage V34 of the lead battery 34 is greater than the charging start voltage V34thL, but smaller than the charging end voltage V34thH. In this case, the controller 23 determines that the person is in the cabin 100 of the vehicle 1 and that the output voltage V34 of the lead battery 34 is smaller than the charging end voltage V34thH. The controller 23 causes the DC-DC converter 21 to work regardless of whether the person is determined to be in the cabin 100 of the vehicle 1, in the time period from the time point t52 to the time point t53 because in the case where the output voltage V34 of the lead battery 34 is smaller than the charging end voltage V34thH, the output voltage V34 may decrease to the charging start voltage V34thL in a short time period so that the electric load 35 may not be used.

In a time period from the time point t53 to a time point t54, the ignition signal SIG is OFF, and the signal SSEAT indicative of the detection result from the seat occupant sensor 24 and the signal SDOOR indicative of the detection result from the door sensor 27 are ON. In the time period from the time point t53 to the time point t54, the output voltage V34 of the lead battery 34 is the charging end voltage V34thH. In this case, the controller 23 determines that the person is in the cabin 100 of the vehicle 1 and that the output voltage V34 of the lead battery 34 is equal to or greater than the charging end voltage V34thH. The controller 23 causes the DC-DC converter 21 and the fan 22 to stop in the time period from the time point t53 to the time period t54.

After the time point t54, the ignition signal SIG and the signal SSEAT indicative of the detection result from the seat occupant sensor 24 and the signal SDOOR indicative of the detection result from the door sensor 27 are all ON. After the time point t54, the output voltage V34 of the lead battery 34 is the charging end voltage V34thH. In this case, the controller 23 determines that the person is in the cabin 100 of the vehicle 1 and the output voltage V34 of the lead battery 34 is equal to or greater than the charging end voltage V34thH. The controller 23 keeps the DC-DC converter 21 and the fan 22 stopped after the time point t54.

When the output voltage V34 of the lead battery 34 is smaller than the charging start voltage V34thL, the charge control apparatus 10 for vehicle of the embodiment causes the lead battery 34 to be charged. Thus, the charge control apparatus 10 prevents the electric load 35 that uses the lead battery 34 as a power source, from being unavailable.

The charge control apparatus 10 for vehicle of the embodiment is mounted in the cabin 100 of the vehicle 1. Thus, the charge control apparatus 10 can realize stable work as compared to a case of being provided outside the cabin 100 of the vehicle 1.

<Workflow of the Electric Power System 2>

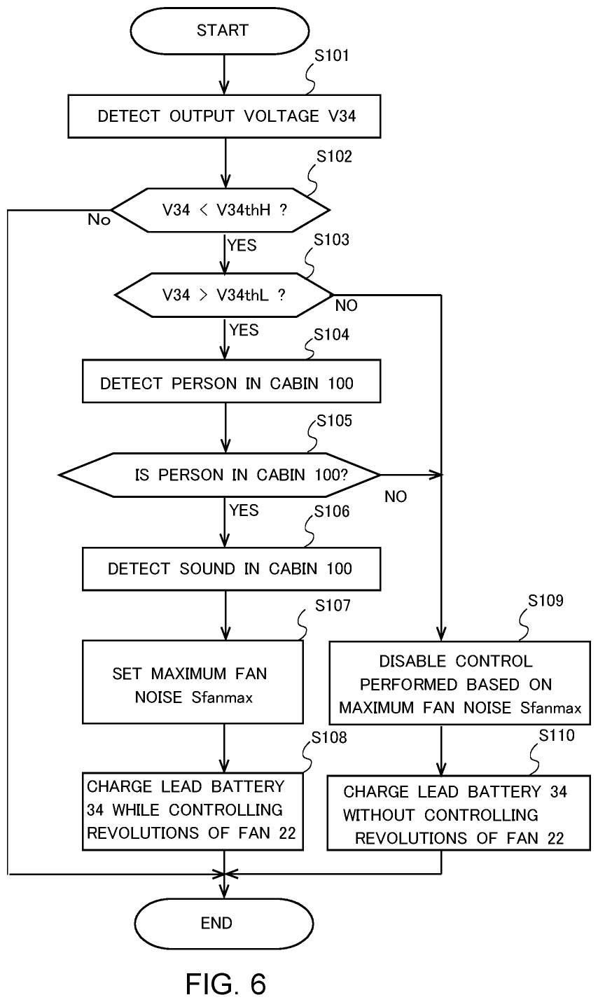

FIG. 6 is a flowchart of the controller 23. The controller 23 performs the workflow regularly.

First, the controller 23 performs a voltage detection process for detecting the output voltage V34 of the lead battery 34, by use of the voltmeter 26 (a step S101). After the step S101, the controller 23 determines whether or not the detected output voltage V34 of the lead battery 34 is below the charging end voltage V34thH (a step S102).

In the step S102, in a case where the output voltage V34 of the lead battery 34 is not below the charging end voltage V34thH (No in the step S102), the controller 23 ends the workflow. In the step S102, in a case where the output voltage V34 of the lead battery 34 is below the charging end voltage V34thH (Yes in the step S102), the controller 23 determines whether or not the detected output voltage V34 of the lead battery 34 is greater than the charging start voltage V34thL (a step S103).

In the step S103, in a case where the output voltage V34 of the lead battery 34 is not greater than the charging start voltage V34thL (No in the step S103), the controller 23 disables the control performed based on the maximum fan noise Sfanmax at a time of charging the lead battery 34 (a step S109). Once disabling the control based on the maximum fan noise Sfanmax, the controller 23 rotates the fan 22 maximally (at the maximum revolution speed). For example, the controller 23 disables the control based on the maximum fan noise Sfanmax in the time period from the time point t31 to the time point t32 in FIG. 3 and in the time period from the time point t51 to the time point t53 in FIG. 5.

After the step S109, the controller 23 controls the DC-DC converter 21 to charge the lead battery 34 (a step S110). In the charging in the step S110, the controller 23 does not control the revolution speed of the fan 22. The charging in the step S110 corresponds to charging in the time period from the time point t51 to the time point t53 in FIG. 5. After the step S110, the controller 23 ends the workflow.

In the step S103, in a case where the output voltage V34 of the lead battery 34 is greater than the charging end voltage V34thH (Yes in the step S103), the controller 23 performs a person detection process for detecting whether or not a person is in the cabin 100 of the vehicle 1 (a step S104).

After the step S104, the controller 23 determines whether or not the person is in the cabin 100 of the vehicle 1 (a step S105). In a case where the controller 23 determines that the no person is in the cabin 100 of the vehicle 1 in the step S105 (No in the step S105), the controller 23 moves to the step S109 and the step S110 sequentially. After the step S110, the controller 23 ends the workflow.

In a case where the controller 23 determines that the person is in the cabin 100 of the vehicle 1 in the step S105 (Yes in the step S105), the controller 23 performs a sound detection process for detecting the volume of sound in the cabin 100 of the vehicle 1 (a step S106). The step S106 corresponds to the step in which the controller 23 calculates the volume of the sound in the cabin 100 based on the output voltage VMIC of the microphone 25 in FIG. 4.

After the step S106, the controller 23 determines the maximum fan noise Sfanmax for the time of charging the lead battery 34 (a step S107). The step S107 corresponds to the step in which the controller 23 determines the maximum fan noise Sfanmax based on the output voltage VMIC of the microphone 25 in FIG. 4.

In the step S107, the controller 23 calculates the volume of the sound in the cabin 100 based on the output voltage VMIC of the microphone 25. The controller 23 determines the maximum fan noise Sfanmax based on the calculated volume of the sound in the cabin 100 of the vehicle 1. The controller 23 determines the maximum fan noise Sfanmax such that the maximum fan noise Sfanmax is smaller than the volume of the sound in the cabin 100. For example, the controller 23 sets 10% of the volume of the sound in the cabin 100 as the maximum fan noise Sfanmax.

In FIG. 4, the maximum fan noise Sfanmax increases as the output voltage VMIC of the microphone 25 increases because the controller 23 determines the maximum fan noise Sfanmax based on the volume of the sound in the cabin 100 of the vehicle 1. Moreover, the maximum fan noise Sfanmax is an allowable maximum volume of the sound (noise) generated by the fan 22. Therefore, in FIG. 4, the fan noise Sfan generated by the fan 22 increases as the maximum fan noise Sfanmax increases.

After the step S107, the controller 23 controls the DC-DC converter 21 to charge the lead battery 34 (a step S108). In the step S108, when the lead battery 34 is charged, the controller 23 controls the revolution speed of the fan 22 to make the fan noise Sfan generated by the fan 22 smaller than the maximum fan noise Sfanmax. After the step S108, the controller 23 ends the workflow.

### Second Embodiment

A configuration of an electric power system 2 of a second embodiment is the same as the configuration of the electric power system 2 of the first embodiment. However, this embodiment is different from the first embodiment in that an ignition signal SIG is ON, and that an engine 31 and a motor generator 32 are working.

In this embodiment, a lithium ion battery 33, the motor generator 32, and a drive motor for a drive wheel 1F (not illustrated) function as a voltage supplier. The motor generator 32 supplies voltage to a DC-DC converter 21 and the lithium ion battery 33. The DC-DC converter 21 converts voltage supplied from at least one of the motor generator 32 and the lithium ion battery 33, and then outputs the converted voltage to a lead battery 34 and an electric load 35. In a case where output from the DC-DC converter 21 is not enough to supply electricity for consumption of the electric load 35, the lead battery 34 supplies electricity to the electric load 35.

The drive motor for the drive wheel IF (not illustrated) supplies voltage to the DC-DC converter 21 and the lithium ion battery 33 when the vehicle 1 slows down, etc. For example, when being used as a regeneration brake, the drive motor for the drive wheel IF (not illustrated) supplies the voltage to the DC-DC converter 21 and the lithium ion battery 33.

(Modification 1)

There may be a case in which the sound in the cabin 100 of the vehicle 1 is extremely small, such as during idle stop. In such a case, the controller 23 may charge the lead battery 34 without activating the fan 22. For example, in a case where a heat amount generated by the DC-DC converter 21 can be dissipated without using the fan 22, the lead battery 34 may be charged without activating the fan 22.

The generated heat amount of the DC-DC converter 21 increases as a power loss in the DC-DC converter 21 increases. In a case where the DC-DC converter 21 works in a little power loss condition, the generated heat amount of the DC-DC converter 21 can decrease. Thus, in a case where the heat amount generated by the DC-DC converter 21 is within a range of the heat amount that the DC-DC converter 21 can dissipate without the fan 22, the DC-DC converter 21 is operable without using the fan 22. Thus, even in a case where there is little sound in the cabin 100 in the vehicle 1, the lead battery 34 can be charged.

The foregoing embodiment described an example in which the temperature adjuster is the fan 22. However, the temperature adjuster is not limited to a fan. The temperature adjuster may be a heat sink, a Peltier device, and other elements that can adjust temperature. Moreover, the temperature adjuster may be a combination of the fan 22, a heat sink, a Peltier device, and the like.

(Modification 2)

The controller 23 may use an estimated volume of sound in the cabin 100 of the vehicle 1 instead of the volume of the sound in the cabin 100 detected by the microphone 25. The estimated volume of the sound in the cabin 100 may be derived from a revolution speed of the engine 31, a travelling speed of the vehicle 1, and the like.

(Modification 3)

Sensitivity to sound varies depending on a person. In other words, sensitivity to a noise of the fan 22 depends on the person who hear the noise. Thus, the maximum fan noise Sfanmax may be adjusted depending on a person in the cabin 100 of the vehicle 1. The maximum fan noise Sfanmax may be adjusted by the person in the cabin 100 of the vehicle 1. For example, there is a person in the cabin 100 who hears especially well sound in a frequency range of the noise that the fan 22 generates. In such a case, the person in the cabin 100 may adjust the maximum fan noise Sfanmax to lower the noise of the fan 22. The controller 23 may store adjustment by the person as a history record, and may use the history record of the adjustment to determine the maximum fan noise Sfanmax in the future.

(Modification 4)

The charge control apparatus 10 for vehicle is mounted in the cabin 100. However, in this modification, a DC-DC converter 21 and a fan 22 may be placed outside the cabin 100. Placing the DC-DC converter 21 and the fan 22 outside the cabin 100 can lower, for a person in the cabin 100, the operation noise of the fan 22 generated along with the work of the DC-DC converter 21. Moreover, the controller 23 and the voltmeter 26 of the charge control apparatus 10 may be placed outside the cabin 100.

(Modification 5)

In the foregoing embodiment, the controller 23 detects whether or not a person is in the cabin 100 by use of the seat occupant sensor 24 and the door sensor 27. However, only one of the seat occupant sensor 24 and the door sensor 27 may be used to detect whether or not a person is in the cabin 100 of the vehicle 1. Moreover, a seatbelt sensor, an infrared ray sensor or the like may be used to detect whether or not a person is in the cabin 100 of the vehicle 1 in addition to the seat occupant sensor 24 and the door sensor 27.

A time period in which a person is not in a seat may be determined as a time period in which a person is not in the cabin 100 of the vehicle 1. In that case, if the controller 23 starts to charge the lead battery 34 immediately after the person rises from his/her seat in the cabin 100 of the vehicle 1, comfort of the person in the cabin 100 may be damaged. Therefore, it is preferable to start charging the lead battery 34 after a time period passes necessary for the person to rise from his/her seat and to come out from the vehicle 1.

(Modification 6)

In the foregoing modification, the motor generator 32 includes a function of a starter that rotates the engine 31 when the engine 31 is started, and a function of a power generator that generates electricity by use of output from the engine 31 when the engine 31 is working. However, the motor generator 32 may be used only as the power generator and a starter may be provided separately. Moreover, a starter and a power generator may be provided separately, instead of the motor generator 32.

(Modification 7)

The foregoing embodiment described an example in which the motor generator 32 rotates the engine 31 by use of the electricity supplied from the lithium ion battery 33 when the engine 31 is started. However, the power source is not limited to the lithium ion battery 33. A starter (not illustrated) may rotate the engine 31 by use of electricity supplied from the lead battery 34 when the engine 31 is started.

(Modification 8)

The foregoing embodiment described an example in which the vehicle 1 includes the engine 31. However, the configuration of the vehicle 1 is not limited to this. The vehicle 1 may not include the engine 31. In a case where the vehicle 1 does not include the engine 31, the vehicle 1 drives the drive wheel IF by use of the drive motor (not illustrated). In other words, the vehicle 1 functions as an electric vehicle.

(Modification 9)

The foregoing embodiment described an example in which the charge control apparatus 10 causes the lead battery 34 to be charged when the output voltage V34 of the lead battery 34 is “below” the charging start voltage V34thL. However, the invention is not limited to this. The charge control apparatus 10 may cause the lead battery 34 to be charged when the output voltage V34 of the lead battery 34 is “equal to or less than” the charging start voltage V34thL so as to further lower a possible that the charge control apparatus 10 cannot use the electric load 35.

The foregoing embodiments described an example in which at least one of the seat occupant sensor 24 and the door sensor 27 is a person detector. However, the invention is not limited to the example. The charge control apparatus 10 does not have to include the seat occupant sensor 24 and the door sensor 27. In this case, the charge control apparatus 10 obtains detection signals from sensors that detect a person. Then, the charge control apparatus 10 may determine whether or not the person is in the cabin 100 based on the obtained detection signals. In this case, a portion that determines whether or not a person is in the cabin 100 based on the obtained detection signals works as a person detector.

The foregoing embodiment described an example in which the fan 22 is a temperature adjuster. However, the invention limited to the example. The charge control apparatus 10 may not include the fan 22. In this case, the charge control apparatus 10 obtains detection signals from sensors that detect a temperature of the voltage converter, and the charge control apparatus 10 may determine, based on the obtained detection signals, whether or not a vehicle temperature adjustment is necessary or a degree of the temperature adjustment. In this case, a temperature adjuster is a portion that determines, based on the obtained detection results, necessity of the temperature adjustment of the vehicle and the level of the temperature adjustment.

In the foregoing embodiments, the controller 23 may be a separate semiconductor chip, such as LSI. The controller 23 may be one chip that includes a portion or all of the functions of the controller 23. Here, one example of the chips is LSI. However, LSI is sometimes called as IC, system LSI, super LSI or ultra LSI, depending on a degree of integration of the chip.

A method of integrating the circuit is not limited to the LSI, and a dedicated circuit or a general-purpose processor may be used. A field programmable gate array (FPGA) programmable after manufacturing or a reconfigurable processor that can reconfigure connection or settings of a circuit cell in the LSI may be used.

Moreover, a portion or all of the process that is performed by the controller 23 may be realized by a program. The portion or all of the processes that are performed by function blocks in the foregoing embodiments is performed by a central processing unit (CPU) in a computer. Programs for executing the processes are stored in a storage such as hard disk and ROM. The programs are executed on the ROM or after being read to the RAM.

Moreover, the processes in the foregoing embodiments may be realized by hardware, software (operating system (OS), middleware, or including a case using a predetermined library). Further, the processes may be realized by a combination of software and hardware.

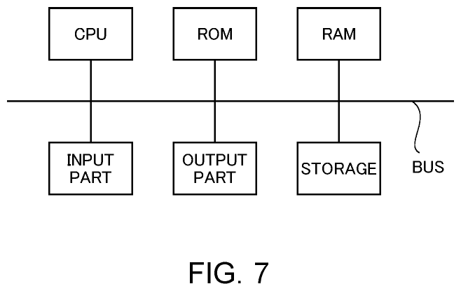

For example, in a case where the controller 23 is realized by software, each function may be realized by software by use of hardware configuration (e.g. hardware configuration connecting a CPU, a ROM, a RAM, an input part and an output part, and the like via BUS) shown in FIG. 7.

Moreover, an order of the steps of each process in the foregoing embodiments are not limited to the description above. The order of the steps may be appropriately changed if the change does not depart from the purpose of the invention.

A computer program that is executed by a computer to perform the foregoing steps and a computer readable record medium that records the computer program are included in a range of this invention. Here, some samples of the computer readable record media are a flexible disk, a hard disk, a CD-ROM, a MO, a DVD, a DVD-ROM, a DVD-RAM, a large capacity DVD, a next generation DVD and a semiconductor memory.

While the invention has been shown and described in detail, the foregoing description is in all aspects illustrative and not restrictive. It is therefore understood that numerous other modifications and variations can be devised without departing from the scope of the invention.

What is claimed is:

1. A vehicle-mounted charge control apparatus comprising:
a voltage converter that converts a voltage output from a voltage supplier on a vehicle and supplies the converted voltage to a storage battery on the vehicle;
a temperature adjuster that adjusts a temperature of the voltage converter while the voltage converter is working;
a person detector that detects whether or not a person is in a cabin of the vehicle; and
a controller that controls the voltage converter to supply the converted voltage to the storage battery in a case where the person detector detects that no person is in the cabin of the vehicle.

2. The vehicle-mounted charge control apparatus according to claim 1, further comprising:
a sound detector that detects sound in the cabin of the vehicle, wherein
in a case where a value of the sound detected by the sound detector is equal to or greater than a predetermined value, the controller controls the voltage converter to work regardless of whether the person is detected by the person detector to be in the cabin of the vehicle.

3. The vehicle-mounted charge control apparatus according to claim 2, wherein
the temperature adjuster includes a fan, and
the controller changes a revolution speed of the fan according to the value of the sound detected by the sound detector.

4. The vehicle-mounted charge control apparatus according to claim 1, further comprising:
a voltage detector that detects an output voltage of the storage battery, wherein
in a case where the output voltage of the storage battery detected by the voltage detector is smaller than a predetermined value, the controller controls the voltage converter to work regardless of whether the person is detected by the person detector to be in the cabin of the vehicle.

5. The vehicle-mounted charge control apparatus according to claim 1, wherein
the vehicle-mounted charge control apparatus is mounted in the cabin of the vehicle.

6. The vehicle-mounted charge control apparatus according to claim 1, wherein
the controller controls the voltage converter to supply the converted voltage to the storage battery in the case where the person detector detects that no person is in the cabin of the vehicle when an ignition signal of the vehicle is in an OFF state.

7. The vehicle-mounted charge control apparatus according to claim 2, wherein
the controller controls the voltage converter to supply the converted voltage to the storage battery in the case where the value of the sound detected by the sound detector is equal to or greater than the predetermined value when an ignition signal of the vehicle is in an accessory-ON state.

8. A vehicle-mounted charge control method comprising the steps of:
(a) converting, by a voltage converter, a voltage output from a voltage supplier on a vehicle and supplying the converted voltage to a storage battery on the vehicle;
(b) adjusting, by a temperature adjuster, a temperature of the voltage converter while the voltage converter is working;
(c) detecting, by a person detector, whether or not a person is in a cabin of the vehicle; and
(d) controlling, by a controller, the voltage converter to supply the converted voltage to the storage battery in a case where the person detector in the step (c) detects that no person is in the cabin of the vehicle.

9. The vehicle-mounted charge control method according to claim 8, further comprising the step of:
(e) detecting, by a sound detector, sound in the cabin of the vehicle, wherein
in a case where a value of the sound detected by the sound detector in the step (e) is equal to or greater than a predetermined value, the controller in the step (d) controls the voltage converter to work regardless of whether the person is detected by the person detector in the step (c) to be in the cabin of the vehicle.

10. The vehicle-mounted charge control method according to claim 9, wherein
the temperature adjuster includes a fan, and
the controller in the step (d) changes a revolution speed of the fan that cools the voltage converter according to the value of the sound detected by the sound detector in the step (e).

11. The vehicle-mounted charge control method according to claim 8, further comprising the step of:
(f) detecting, by a voltage detector, an output voltage of the storage battery, wherein
in a case where the output voltage of the storage battery detected by the voltage detector in the step (f) is smaller than a predetermined value, the controller in the step (d) controls the voltage converter to work regardless of whether the person is detected by the person detector in the step (c) to be in the cabin of the vehicle.

12. The vehicle-mounted charge control method according to claim 8, wherein
in the step (d), the controller controls the voltage converter to supply the converted voltage to the storage battery in the case where the person detector detects that no person is in the cabin of the vehicle when an ignition signal of the vehicle is in an OFF state.

13. The vehicle-mounted charge control method according to claim 9, wherein
in the step (d), the controller controls the voltage converter to supply the converted voltage to the storage battery in the case where the value of the sound detected by the sound detector is equal to or greater than the predetermined value when an ignition signal of the vehicle is in an accessary-ON state.
